(19) United States
(12) Patent Application Publication
(10) Pub. No.: US 2006/0036792 A1
(43) Pub. Date: Feb. 16, 2006

(54) Method of Reducing Interrupts In a Processor

(76) Inventor: Chien-yu Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,642

(22) Filed: Aug. 10, 2005

(30) Foreign Application Priority Data
Aug. 11, 2004 (TW) 093124075

(51) Int. Cl. G06F 13/26

(52) U.S. Cl. 710/264

(57) ABSTRACT

Reducing interrupts includes setting the priority of a plurality of interrupts according to the properties of the plurality of interrupts, combining at least one of the plurality of interrupts and an interrupt of highest priority into an interrupt group according to executable time of the interrupts, and a processor continuously executing each interrupt group. This will effectively reduce interrupts and increase system efficiency.

### BACKGROUND OF THE INVENTION

1. Field of the Invention

The present invention relates to signal processing, more particularly, a method of reducing interrupts in a processor.

2. Description of the Prior Art

A modern signal communication system usually comprises a digital signal processor, a micro control unit and a timing processor unit. In the process of running programs in the digital signal processor, when a user suddenly executes a command related to a different job, this job should be completed immediately. At this time, the digital signal processor receives a priority interrupt and goes into an interrupt mode. The timing processor unit is capable of controlling the interrupt time of the digital signal processor and the micro control unit. The timing processor unit needs to place priority interrupts of the digital signal processor first in accordance with the next batch of interrupts. The digital processor unit executes an interrupt in schedule after the micro control unit.

As those skilled in the art know, in a general real-time system, when an external device such as a port device or a bus raises a priority interrupt, an executive unit such as a central processing unit or digital signal processor receives and executes the priority interrupt corresponding to an interrupt service routine (ISR). But, when the external device raises a plurality of interrupts, these interrupts do not need to be processed immediately. Moreover, if the external device executes another priority interrupt and correspondingly executes the interrupt service routine repeatedly, it can cause interference to the central processing unit or digital signal processor, and leads to low system efficiency and increasing difficulty of debugging. Overall, this causes unpredictable interference and affects the efficiency of the entire system.

### SUMMARY OF THE INVENTION

It is therefore an object of the claimed invention to provide a method of reducing interrupts to a processor.

A method of reducing interrupts in a processor comprising setting priorities of a plurality of interrupts according to properties of the plurality of interrupts, combining one or more interrupts with an interrupt of a highest priority in a schedule into an interrupt group according to execution times of the interrupts, and the processor continuously executing each interrupt in the interrupt group during operation.

A computer system capable of reducing interrupts comprising a micro control unit for setting priorities of a plurality of interrupts according to properties of the plurality of interrupts, a schedule device for combining one or more interrupts and an interrupt of a highest priority in a schedule into an interrupt group according to execution times of the interrupts, and a processor for executing each interrupt continuously in the interrupt group during operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a mobile communication system.

FIG. 2 illustrates a flowchart of a method of reducing interrupts according to the present invention.

FIG. 3 illustrates a flowchart of a method of arranging a priority of each interrupt according to the present invention.

FIG. 4 illustrates a flowchart of a method of reducing interrupts and scheduling a plurality of interrupts according to the present invention.

FIG. 5 illustrates a diagram of a list of a plurality of interrupts being carried out.

FIG. 6 illustrates a diagram of a method of carrying out a schedule of priority interrupts according to the present invention.

FIG. 7 illustrates a block diagram of a computer system capable of reducing interrupts according to the present invention.

### DETAILED DESCRIPTION

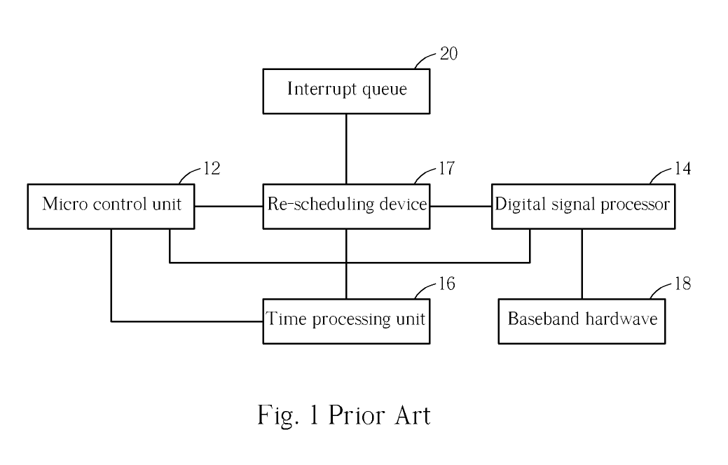

Please refer to FIG. 1. FIG. 1 illustrates a block diagram of a mobile communication system 10. The mobile communication 10 comprises a micro control unit 12, a digital signal processor 14, a timing processor unit 16, an interrupt queue 20, a re-schedule device 17 and a baseband hardware 18. The micro control unit 12 receives a plurality of interrupts and begins a schedule to decide the priority of each interrupt in a schedule and execution time. The re-schedule device 17, according to the micro control unit 12, addresses the priority of each interrupt in a schedule and processing time, in order to re-schedule the next interrupt accordingly to the digital signal processor 14 and the micro control unit 12. In the present invention, the purpose of the re-schedule device 17 is to merge possible priority interrupts into an interrupt group. Hence, an interrupt executed is the interrupt from the interrupt group, and it is not important to know which interrupt has priority. Thus, the re-schedule device 17 is able to reduce the interrupts in a system and increase the efficiency of the digital signal processor 14. An interrupt is sent to the timing processor 16 after processing by the re-schedule device 17 to produce a real interrupt time and also interrupt information including an interrupt identifier and an interrupt parameter. Both the interrupt time and the interrupt information are stored in the interrupt queue 20. Both the micro control unit 12 and the digital signal processor 14 share the interrupt queue 20. When the digital signal processor 14 receives an interrupt command, the interrupt queue 20 utilizes the interrupt time and the interrupt information stored to execute the command. The baseband hardware 18 can include a timing controller, signal transmission interface, analog baseband hardware, or RF hardware.

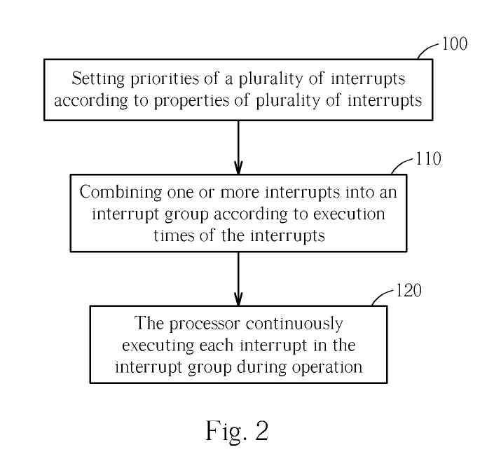

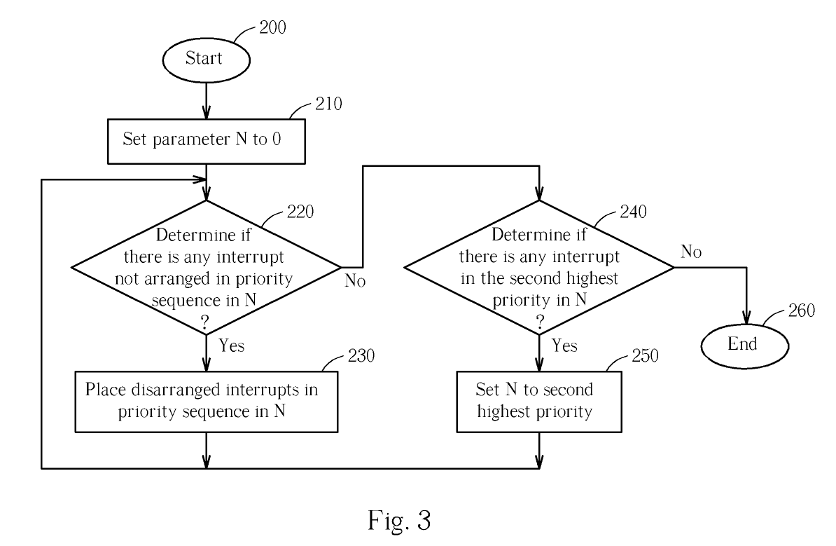

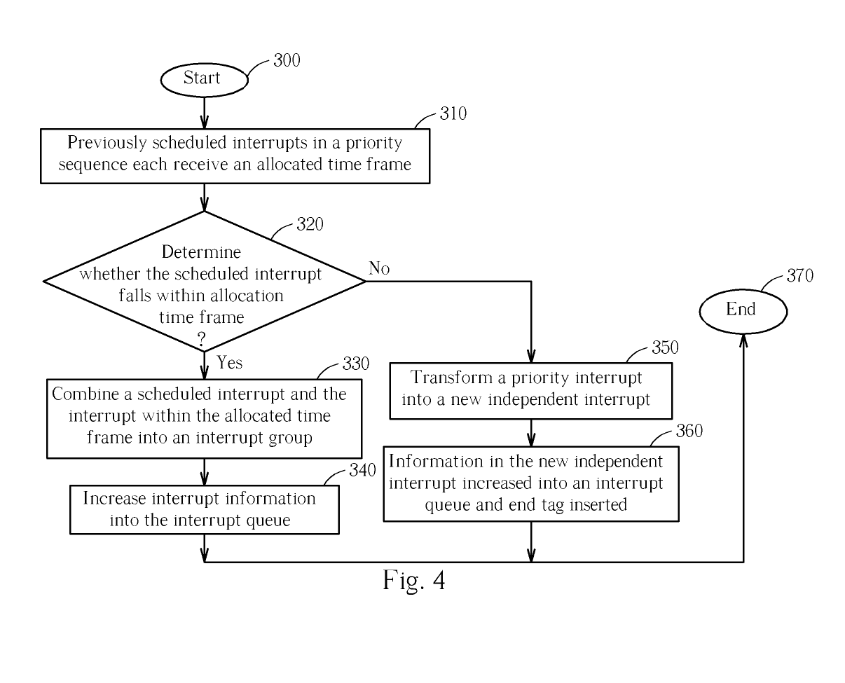

Please refer to FIG. 2. FIG. 2 illustrates a flowchart of a method of reducing interrupts according to the present invention as applied to a processor. Firstly in step 100, a priority sequence level is set in accordance to a plurality of priority interrupts. Different priority interrupts have different execution lengths of time and execution durations. The shorter the given time limit of a priority interrupt, the shorter the duration. In setting the priority sequence, the shorter the time limit given, the higher the priority; in other words, the given priority of an interrupt does not affect its given time. Whereas, an interrupt with lower priority has more freedom and flexibility in re-scheduling. In step 110 the method combines one or more interrupts with an interrupt of a highest priority in a schedule into an interrupt group according to execution times of the interrupts. In doing so, the present invention needs to follow a principle, that is, the interrupt time of each interrupt of an interrupt group needs to fall into an execution time of each interrupt. In step 120 the processor executes each interrupt continuously in the interrupt group during operation. In regards to interrupts that are unable to be combined into an interrupt group, these interrupts are executed individually. Step 100 and step 110 are further explained in FIG. 3 and FIG. 4.

Please refer to FIG. 3. FIG. 3 illustrates a flowchart of a method of arranging each interrupt into priority sequence. After beginning in step 200, in step 210, N is set to 0, wherein decreasing value of N represents increasing priority (i.e. 0 is highest priority). Step 220 determines if there is any interrupt not arranged in priority sequence in the group indexed by N. If the result is Yes, step 230 places disarranged interrupts into priority sequence into the group N. Then the method repeats step 220. On the other hand, if result is No, step 240 determines whether if there is any interrupt in the second highest priority in the group indexed by N. If the result is Yes in step 240, the group indexed by N is then set to second highest priority in step 250, and step 220 is repeated. When the result is No in step 240, step 260 ends the sequence. FIG. 3 arranges each interrupt in the flowchart for a priority sequence to allow the invention run better, the concept being to place the highest priority first and the second highest priority second, and so on.

FIG. 4 illustrates a flowchart of an arrangement of an interrupt group. Step 300 begins the flowchart, followed by step 310 in which previously scheduled interrupts in a priority sequence each receive an allocated time frame. Step 320 determines whether the scheduled interrupt falls within the allocated time frame. If the result is Yes, step 330 is executed, if the result is No, step 350 is then executed. Step 330 combines a scheduled interrupt and the interrupt within the allocated time frame into an interrupt group. Next, step 340 gathers interrupt information such as an interrupt identifier from a priority interrupt and interrupt parameter, increases the interrupt queue, and schedules a priority interrupt to insert an end tag. Step 350 transforms a priority interrupt into a new independent interrupt, then step 360 is performed in which information in the new independent interrupt increases into an interrupt queue, before lastly an end tag is inserted. Step 370 ends the whole sequence. To conclude the above sequence, step 320 determines whether to put a priority interrupt into an independent interrupt or into an interrupt group. In steps 330 to 340, an interrupt group is formed and inserted into an interrupt queue. An end tag indicates the end of the interrupt group. As previously mentioned, an interval between a first and second interrupt of an interrupt group is bracketed by the execution time of the first interrupt. The flowchart in FIG. 4 illustrates the implementation of the arrangement of each interrupt. This method of arranging a suitable interrupt into an interrupt group achieves the objective of this embodiment of the present invention.

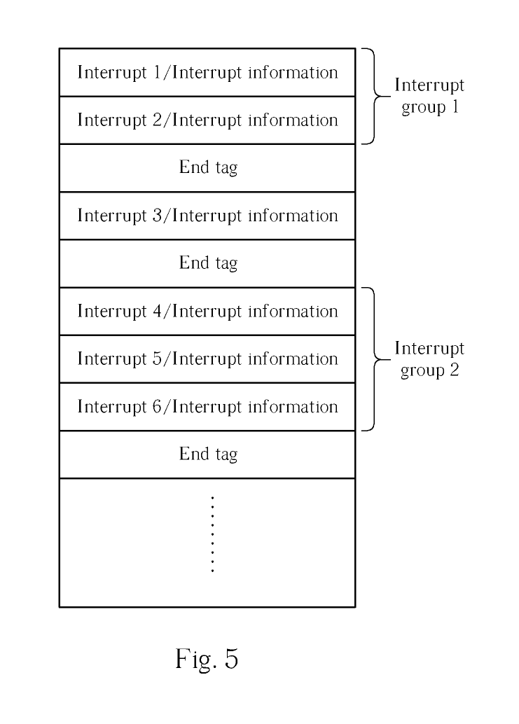

Please refer to FIG. 5, which is a diagram of an interrupt queue 20 of an embodiment according to the present invention, which is capable of storing a plurality of interrupts or interrupt information and a plurality of end tags, in which some interrupts are grouped into an interrupt group. For example, interrupt group 1 includes interrupt 1 and interrupt 2, and interrupt group 2 includes interrupts 4, 5, and 6. As for interrupt 3, it is an independent interrupt. An end tag separates each interrupt group and each independent interrupt. A processor continuously executes interrupts in an interrupt request queue and stops when an end tag is reached.

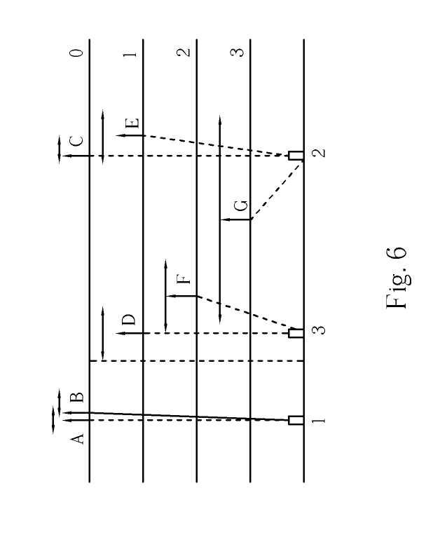

FIG. 6 illustrates a diagram of a method of carrying out a schedule of priority interrupts according to the present invention. FIG. 6 illustrates the process of executing seven interrupts A, B, C, D, E, F, and G sequentially. The vertical axis represents processing time and the numbers 0 to 3 represent different levels of priority sequence. A, B and C are placed on 0 line which represent the highest priority. D and E on line 1 are second highest priority in the sequence. And F & G are respectively third and fourth in sequence. Amongst all the interrupts, A has the highest priority due to its shortest time. As A and B both have an overlap in time, A and B combine to form an interrupt group. C is next on the sequence. As the processing time of G and E also includes C, therefore C is combined with E and G to form a second interrupt group. After line 0 is completed, it is followed by the next line 1, only D is processed individually due the overlapping time of F and D, hence a third interrupt group is formed.

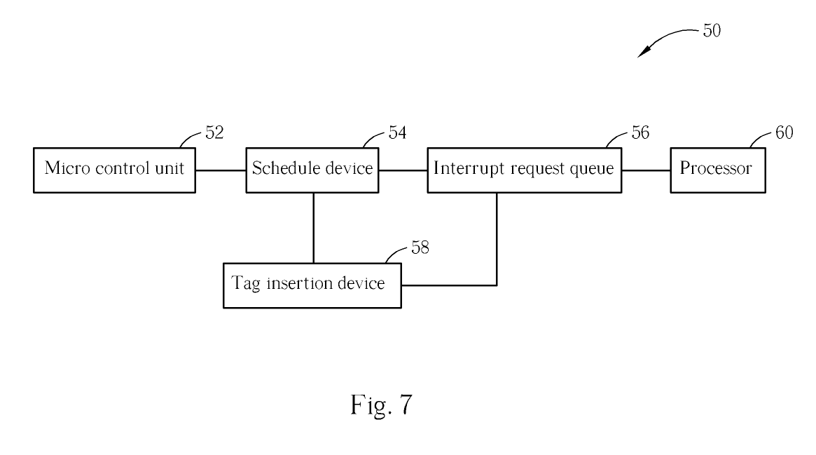

FIG. 7 is a block diagram illustrating a computer system 50 capable of reducing interrupts. The computer system 50 comprises a micro control unit 52 for setting priorities of a plurality of interrupts according to properties of the plurality of interrupts, wherein during the process of setting a priority sequence, the shorter the time limit given, the higher the priority, in another words, in the given priority of an interrupt does not affect its given time. Whereas, an interrupt with lower priority has more freedom and flexibility of re-scheduling. The computer system 50 further comprises a schedule device 54 for combining suitable interrupts in a plurality of interrupts to form an interrupt group according to the execution time of the plurality of interrupts. An interval must fall between a first and second interrupt in an interrupt group bracketed by the execution time of the first interrupt. The computer system 50 also has an interrupt request queue 56 for storing interrupt groups from the schedule device 54 in sequence, a tag insertion device 58 for inserting an end tag in between individual interrupts or interrupt groups in the interrupt request queue 56 in order to temporarily stop the processor 60 during execution, and a processor 60 for executing each interrupt continuously in the interrupt group during operation. To conclude, the micro control unit 52 controls step 100 in FIG. 2, the schedule device 54 executes step 110 in FIG. 2, and lastly, the processor 60 executes step 120 in FIG. 2.

As those skilled in the art will recognize, in a general real-time system, when an external device such as a port device or a bus issues a priority interrupt, an executive unit such as central processing unit or digital signal processor receives and executes the priority interrupt corresponding to the interrupt service routine. But when the external device puts forward a plurality of interrupts and if the external device executes a priority interrupt and correspondingly executes an interrupt service routine repeatedly, it can cause interference to the central processing unit or digital signal processor, which can lead to low system efficiency and increasing difficulty in debugging. Overall, this situation causes unpredictable interference and affects the efficiency of the entire system. In comparison to the prior art, the present invention sets levels of priority in accordance to the properties of a plurality of interrupts, such as execution time of the plurality of interrupts. Thus the present invention combines one or more interrupts with an interrupt of a highest priority in a schedule into an interrupt group. Also the processor continuously executes each interrupt in the interrupt group hence the method of the present invention is capable of reducing interrupts and increases system efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing interrupts in a processor comprising the following steps:
(a) setting priorities of a plurality of interrupts according to properties of the plurality of interrupts;
(b) combining one or more interrupts with an interrupt of a highest priority in a schedule into an interrupt group according to execution times of the interrupts; and
(c) the processor continuously executing each interrupt in the interrupt group during operation.

2. The method of claim 1 wherein the properties of the plurality of interrupts comprise execution times of the interrupts.

3. The method of claim 2 wherein the higher the priority of an interrupt the sooner the execution time of the interrupt.

4. The method of claim 1 further comprising after executing step (c), inserting an end tag to stop the processor from executing an interrupt in the schedule.

5. The method of claim 1 wherein an interval between a first and second interrupt in an interrupt group is bracketed by the execution time of the first interrupt.

6. The method of claim 1 wherein according to the execution times of the plurality of interrupts in step (b) combines one or more unscheduled interrupts with a scheduled interrupt of the highest priority into an interrupt group.

7. The method of claim 1 further comprising after the combining of step (b), according to the execution times of a plurality of unscheduled interrupts, combining one or more unscheduled interrupts with an unscheduled interrupt of the highest priority into an interrupt group.

8. A computer system comprising:
a micro control unit for setting priorities of a plurality of interrupts according to properties of the plurality of interrupts;
a schedule device for combining one or more interrupts and an interrupt of a highest priority in a schedule into an interrupt group according to execution times of the interrupts; and
a processor for executing each interrupt continuously in the interrupt group during operation.

9. The computer system of claim 8 further comprising an interrupt queue for storing an interrupt group into the schedule device sequentially after the schedule.

10. The computer system of claim 9 further comprising an end tag device for stopping the processor from executing the schedule after inserting an end tag into the interrupt queue of an interrupt group.
